(19) United States
(12) Patent Application Publication
(10) Pub. No.: US 2015/0362254 A1
(43) Pub. Date: Dec. 17, 2015

(54) Heating Device For Detecting And Preventing A High-Temperature Metal Material From Leaking

(71) Applicant: Shenzhen China Star Optoelectronic Technology Co., Ltd., Shenzhen, Guangdong (CN)

(72) Inventor: Youyuan KUANG, Shenzhen, Guangdong (CN)

(73) Assignee: Shenzhen china Star Optoelectronics Technology Co. Ltd., Shenzhen, Guangdong (CN)

(21) Appl. No.: 14/378,599

(22) PCT Filed: Jul. 2, 2014
(86) PCT No.: PCT/CN2014/081447

§ 371 Date: Aug. 13, 2014

(30) Foreign Application Priority Data
Jun. 16, 2014 (CN) 201410268429.9

(51) Int. Cl. F27D 21/04; F27D 21/00

(52) U.S. Cl. CPC F27D 21/04; F27D 21/00; F27D 2021/0085

(57) ABSTRACT

A heating device for detecting and preventing a high-temperature metal material from leaking includes an inner heating container for containing the high-temperature metal material, an outer heating container disposed outside the inner heating container, multiple terminals disposed at a bottom of the inner heating container and disposed without contacting a bottom of the outer heating container, an insulation connector connecting the inner heating container and the outer heating container, a power source; and an indication device. When the high-temperature metal material is leaked to the outer heating container, one or more of the multiple terminals contact the leaked high-temperature metal material to electrically connect the inner heating container, the outer heating container, the power source, and the indication device, and to trigger the indication device to work in order to determine that the high-temperature metal material is leaked and executing steps timely to prevent from leaking further.

### BACKGROUND OF THE INVENTION

1. Field of the Invention

The present invention relates to an OLED manufacturing process field, and more particularly to a heating device for detecting and preventing a high-temperature metal material from leaking.

2. Description of Related Art

An organic light-emitting diode (OLED) display device has a self-luminous property, which uses a very thin organic material coating layer and a glass substrate. When a current is flowing through, the organic material will emit lights. The OLED display device can significantly save energy, and has advantages of an all-solid-state, ultra-thin, no viewing angle restriction, fast response, working at room temperature, easy to implement flexible display and 3D display, etc. Therefore, the OLED display device is widely considered to be consistent with the mainstream of the next-generation display technology.

Currently, the fabrication of the OLED device is heated evaporation to coating a film. The fabrication process uses a heating container to heat the evaporation material in a vacuum environment, so that the sublimation type or melt type material is gasified at a high temperature, and the material is deposited on a substrate having a TFT structure or an anode structure.

In the current OLED evaporation process, a single layer heating container is usually used to heat a metal material such that the metal material is evaporated. With reference to FIG. 1, FIG. 1 is a schematic perspective diagram of a heating container used in an OLED evaporation process according to the prior art. The heating container 100 is a single-layer structure. The bottom of the heating container 100 is closed. The top of the heating container 100 is provided with a through hole 110. A metal material 900 contained in the heating container 100 is melted and evaporated after being heated, and the metal material 900 escapes through the through hole 110 to execute coating on the substrate.

The above technical solution has some drawbacks, mainly occurred in the heating and cooling process, a junction portion of the side wall and the bottom of the heating container 100 usually generates micro cracks because of the condensation and shrinkage of the metal material 900. Leakage portions 400 are generated at the heating container 100 such that the metal material 900 flows out abnormally. As a result, the metal material 900 is greatly lost, the evaporation rate is decreased, and the production cost is increased. Besides, the leakage portions 400 will cause the high-temperature metal material flowing out and entering into the heating equipment such that the circuit in the heating equipment is shorted. The heating equipment will be broken so that the production of the OLED product is interrupted, and the product quality is decreased. Because the micro cracks are not easy to find in a cooled state so that finding that the heating container is broken and leaked is very difficult, and hard to detect in advance. The technical person is observed by eyes or according to the experience. The accuracy is low and having the lag such that the heating container cannot be timely fixed or replaced.

### SUMMARY OF THE INVENTION

The object of the present invention is to provide a heating device for detecting and preventing a high-temperature metal material from leaking. The heating device can timely and conveniently detect the leakage of the high-temperature metal material in order to instruct the technical person to execute corresponding steps to prevent the high-temperature metal material from leaking further. The heating device can overcome the problem of losing metal material because of the damage of the heating container in order to reduce the cost, protect the heating device, and maintain the normal and steady production of the OLED.

To achieve the above object, the present invention provides a heating device for detecting and preventing a high-temperature metal material from leaking, comprising: an inner heating container for containing the high-temperature metal material; an outer heating container disposed outside the inner heating container; multiple terminals disposed at a bottom of the inner heating container and disposed without contacting a bottom of the outer heating container; an insulation connector connecting the inner heating container and the outer heating container; a power source; and an indication device;

wherein, when the high-temperature metal material is not leaked, the inner heating container, the outer heating container, the multiple terminals, the power source, and the indication device form an open circuit; when the high-temperature metal material is leaked to the outer heating container, one or more of the multiple terminals contact the leaked high-temperature metal material so as to electrically connect the inner heating container, the outer heating container, the power source, and the indication device, and to trigger the indication device to work in order to determine that the high-temperature metal material is leaked and executing steps timely so as to prevent the high-temperature metal material from leaking further.

Wherein, the each of the multiple terminals has a high resistance.

Wherein, the multiple terminals are different in length; each of the multiple terminals does not contact with the bottom of the outer heating container; the indication device comprises multiple indication lights electrically connected with the power source; when the high-temperature metal material is leaked to the outer heating container, one or more of the multiple terminals contact with the leaked high-temperature metal material so as to electrically connect the inner heating container, the outer heating container, the power source, and the indication device, and to trigger one or more of the indication lights to emit lights in order to determine that the high-temperature metal material is leaked, and to determine that the degree of the leakage according to the number of the indication lights which emitting lights.

Wherein, the inner heating container and the outer heating container are both made of electrically conductive materials, and the materials for the inner heating container and the outer heating container are the same.

Wherein, an inner diameter of the outer heating container is larger than an outer diameter of the inner heating container; a height of the outer heating container is greater than a height of the inner heating container.

Wherein, a top of the inner heating container is provide with a through hole, and the metal material is used for an organic light-emitting diode (OLED) evaporation process.

Wherein, the insulation connector connects the top of the inner heating container and a top of the outer heating container.

Wherein, the multiple terminals are fixed to the bottom of the inner heating container through welding.

Wherein, the power source is a micro button cell battery; each of the multiple indication lights has an initial current and a color, and the initial currents and the colors are different; when a current is lower than the initial current of one of the multiple indication lights, the one of the multiple indication lights does not emit lights, and the current only flows through the one of the multiple indication lights; when a current reaches the initial current of the one of the multiple indication lights, the one of the multiple indication lights emits lights.

Wherein, the number of the multiple terminals is at least two; the number of the multiple indication lights is at least two; the number of the multiple terminals is equal to the number of the multiple indication lights; the multiple terminals form a parallel connection relationship; the multiple indication lights form a series connection relationship.

To achieve the above object, the present invention also provides a heating device for detecting and preventing a high-temperature metal material from leaking, comprising: an inner heating container for containing the high-temperature metal material; an outer heating container disposed outside the inner heating container; multiple terminals disposed at a bottom of the inner heating container and disposed without contacting a bottom of the outer heating container; an insulation connector connecting the inner heating container and the outer heating container; a power source; and an indication device;

wherein, when the high-temperature metal material is not leaked, the inner heating container, the outer heating container, the multiple terminals, the power source, and the indication device form an open circuit; when the high-temperature metal material is leaked to the outer heating container, one or more of the multiple terminals contact the leaked high-temperature metal material so as to electrically connect the inner heating container, the outer heating container, the power source, and the indication device, and to trigger the indication device to work in order to determine that the high-temperature metal material is leaked and executing steps timely so as to prevent the high-temperature metal material from leaking further;

wherein, the each of the multiple terminals has a high resistance;

wherein, the multiple terminals are different in length; each of the multiple terminals does not contact with the bottom of the outer heating container; the indication device comprises multiple indication lights electrically connected with the power source; when the high-temperature metal material is leaked to the outer heating container, one or more of the multiple terminals contact with the leaked high-temperature metal material so as to electrically connect the inner heating container, the outer heating container, the power source, and the indication device, and to trigger one or more of the indication lights to emit lights in order to determine that the high-temperature metal material is leaked, and to determine that the degree of the leakage according to the number of the indication lights which emitting lights;

wherein, the inner heating container and the outer heating container are both made of electrically conductive materials and the materials for the inner heating container and the outer heating container are the same;

wherein, an inner diameter of the outer heating container is larger than an outer diameter of the inner heating container; a height of the outer heating container is greater than a height of the inner heating container;

wherein, a top of the inner heating container provides with a through hole, and the metal material is used for an organic light-emitting diode (OLED) evaporation process;

wherein, the insulation connector connects the top of the inner heating container and a top of the outer heating container.

wherein, the multiple terminals are fixed to the bottom of the inner heating container through welding;

wherein, the power source is a micro button cell battery; each of the multiple indication lights has an initial current and a color, and the initial currents and the colors are different; when a current is lower than the initial current of one of the multiple indication lights, the one of the multiple indication lights does not emit lights, and the current only flows through the one of the multiple indication lights; when a current reaches the initial current of the one of the multiple indication lights, the one of the multiple indication lights emits lights; and

wherein, the number of the multiple terminals is at least two; the number of the multiple indication lights is at least two; the number of the multiple terminals is equal to the number of the multiple indication lights; the multiple terminals form a parallel connection relationship; the multiple indication lights form a series connection relationship.

The beneficial effects of the present invention: the heating device for detecting and preventing a high-temperature metal material from leaking of the present invention can observe the emitting status of the indication lights of the indication device through disposing a two-layer structure of the inner heating container and the outer heating container, and disposing the terminals with different lengths, the power source, and the indication device. The heating device can timely and conveniently detect the leakage of the high-temperature metal material in order to instruct the technical person to execute corresponding steps to prevent the high-temperature metal material from leaking further. The heating device can overcome the problem of losing metal material because of the damage of the heating container in order to reduce the cost, protect the heating device, and maintain the normal and steady production of the OLED.

### BRIEF DESCRIPTION OF THE DRAWINGS

FIG. 1 is a schematic perspective diagram of a heating container according to the prior art;

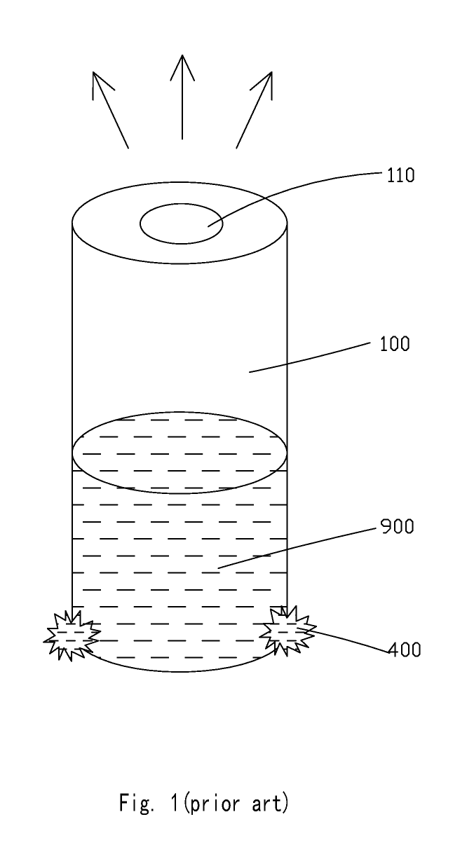

FIG. 2 is a schematic perspective diagram of a heating device for detecting and preventing a high-temperature metal material from leaking according to the present invention;

FIG. 3 is a schematic top view of a heating device for detecting and preventing a high-temperature metal material from leaking according to the present invention;

FIG. 4 is a schematic sectional view of a heating device for detecting and preventing a high-temperature metal material from leaking according to the present invention;

FIG. 5 is an equivalent circuit diagram corresponding to FIG. 4;

FIG. 6 is a schematic sectional view of a heating device for detecting and preventing a high-temperature metal material from leaking according to the present invention;

FIG. 7 is an equivalent circuit diagram corresponding to FIG. 6;

FIG. 8 is a schematic sectional view of a heating device for detecting and preventing a high-temperature metal material from leaking when a large amount of the high-temperature metal material is leaked according to the present invention; and

FIG. 9 is an equivalent circuit diagram corresponding to FIG. 8.

### DETAILED DESCRIPTION OF THE PREFERRED EMBODIMENT

The following content combines with the preferred embodiment and the accompanying drawings for a detailed description of the present invention.

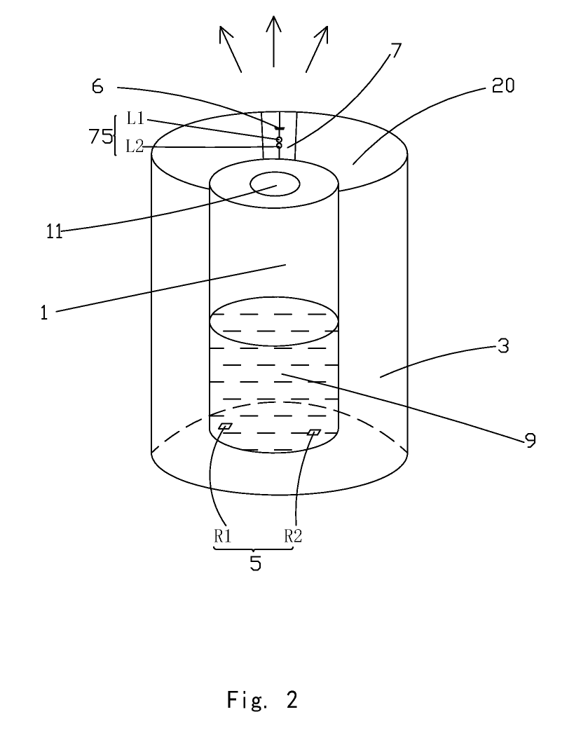

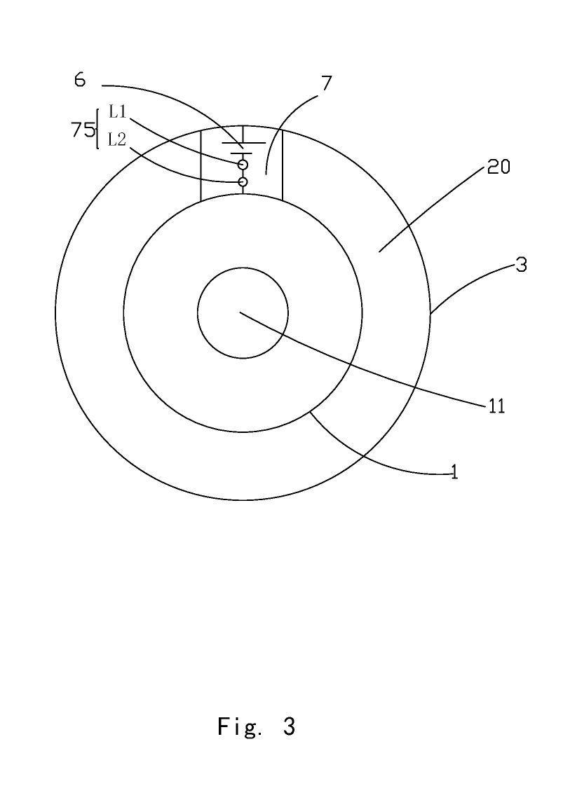

With reference to FIG. 2 to FIG. 4, the heating device for detecting and preventing a high-temperature metal material from leaking of the present invention comprises: an inner heating container 1 for containing a high-temperature metal material 9, an outer heating container 3 disposed outside the inner heating container 1, multiple terminals 5 disposed at a bottom of the inner heating container 1 and dispose without contacting a bottom of the outer heating container 3, an insulation connector 20 connecting the inner heating container 1 and the outer heating container 3, a power source 6, and an indication device 7.

When the high-temperature metal material 9 is not leaked, the inner heating container 1, the outer heating container 3, the multiple terminals 5, the power source 6, and the indication device 7 form an open circuit. When the high-temperature metal material 9 is leaked to the outer heating container 3, one or more of the multiple terminals 5 contact with the leaked high-temperature metal material 9 so as to electrically connect the inner heating container 1, the outer heating container 3, the power source 6, and the indication device 7. The indication device 7 is triggered to work in order to determine that the high-temperature metal material 9 is leaked and executing corresponding steps timely so as to prevent the high-temperature metal material 9 from leaking further.

Specifically, the metal material 9 is used for an organic Light-Emitting Diode (OLED) evaporation process.

The inner heating container 1 and the outer heating container 3 are both made of electrically conductive materials, and the materials for the inner heating container 1 and the outer heating container 3 are the same.

The inner heating container 1 is substantially cylindrical. The bottom of the inner heating container 1 is closed. The top of the inner heating container 1 is provide with a through hole 11. The through hole 11 provides a channel for disposing the metal material 9 into the inner heating container 1 and for evaporation of the high-temperature metal material 9 after being heated and melted. The outer heating container 3 is substantially cylindrical. The bottom of the outer heating container 3 is closed. The top of the outer heating container 3 is opened. Of course, the inner heating container 1, and the outer heating container 3 can be other shapes according to the actual production requirement.

An inner diameter of the outer heating container 3 is larger than an outer diameter of the inner heating container 1. A height of the outer heating container 3 is greater than a height of the inner heating container 1 in order to dispose the inner heating container 1 into the outer heating container 3.

The insulation connector 20 connecting the top of the inner heating container 1 and the top of the outer heating container 3 in order to insulate the inner heating container 1 and the outer heating container 3, and to prevent the side walls of the inner heating container 1 and the outer heating container 3 from contacting directly so as to cause a short circuit.

Each of the multiple terminals 5 has a high resistance. The multiple terminals 5 are fixed to the bottom of the inner heating container 1 through welding. The number of the multiple terminals 5 is at least two. The multiple terminals 5 are different in length. Each of the multiple terminals 5 does not contact with the bottom of the outer heating container 3.

The power source 6 and the indication device 7 are disposed between the top of the inner heating container 1 and the top of the outer heating container 3. The power source 6 is a micro button cell battery. The indication device 7 comprises multiple indication lights 75 electrically connected with the micro button cell battery. The number of the multiple indication lights 75 is at least two. The number of the multiple terminals 5 is equal to the number of the multiple indication lights 75. Each of the multiple indication lights 75 has an initial current and a color. The initial currents and the colors are different. When a current is lower than the initial current of one of the multiple indication lights 75, the one of the multiple indication lights 75 does not emit lights, and the current only flows through the one of the multiple indication lights 75. When a current reaches the initial current of the one of the multiple indication lights 75, the one of the multiple indication lights 75 emits lights.

The multiple terminals 5 form a parallel connection relationship. The multiple indication lights 75 form a series connection relationship. When the high-temperature metal material 9 is leaked to the outer heating container 3, one or more of the multiple terminals 5 contact with the leaked high-temperature metal material 9 such that the inner heating container 1, the outer heating container 3, the power source 6, and the indication device 7 are electrically conductive so as to trigger one or more of the indication lights 75 to emit lights in order to determine that the high-temperature metal material 9 occurs leakage, and determine that the degree of the leakage according to the number of the indication lights 75 which emits lights. Therefore, instructing the technical person to execute corresponding steps in order to prevent the high-temperature metal material from leaking further.

The following uses two terminals 5 including a first high resistance terminal R1 and a second high resistance terminal R2, and two indication lights 75 including a first indication light L1 and a second indication light L2 as an example to illustrate the operation principle of the heating device for detecting and preventing the high-temperature metal material from leaking according to the present invention.

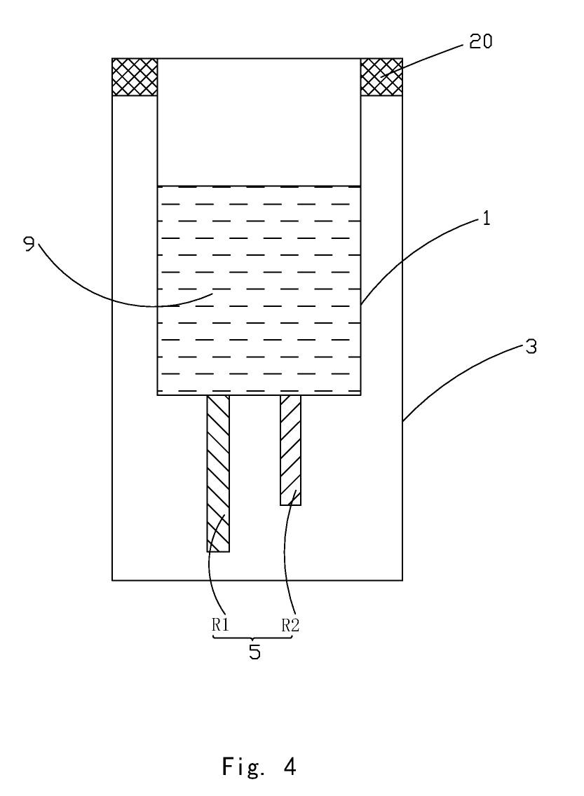

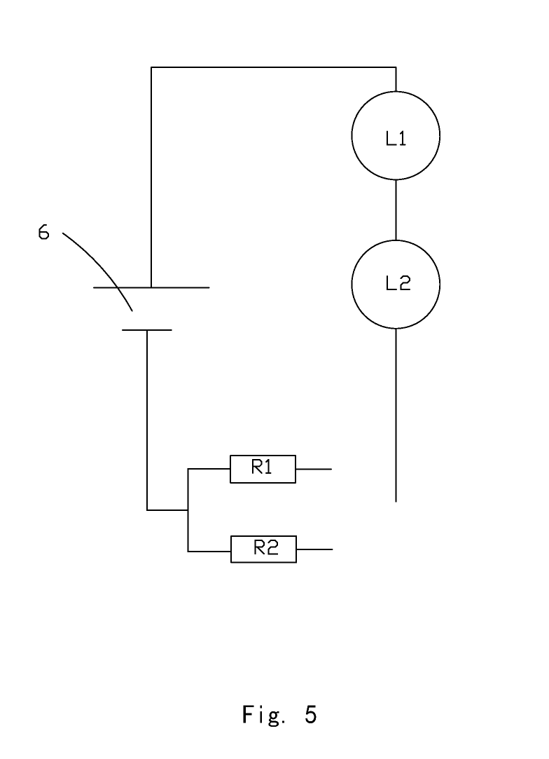

A length of the first high resistance terminal R1 is greater than a length of the second high resistance terminal R2. An initial current of the first indication light L1 is I1, and an initial current of the second indication light L2 is I2, wherein, I2 is greater than I1. When the heating device is working, the outer heating container 3 is heated, and the inner heating container 1 receives the heat through thermal conduction or thermal radiation to heat the metal material 9 until the metal material 9 is melted and evaporated. Whit reference to FIG. 4 and FIG. 5, when the inner heating container 1 is intact, does not generate the micro cracks, and the high-temperature metal material 9 does not leak after being heated. The inner heating container 1, the outer heating container 3, the multiple terminals 5, the power source 6, and the indication device 7 form an open circuit. The indication lights 75 do not emit lights.

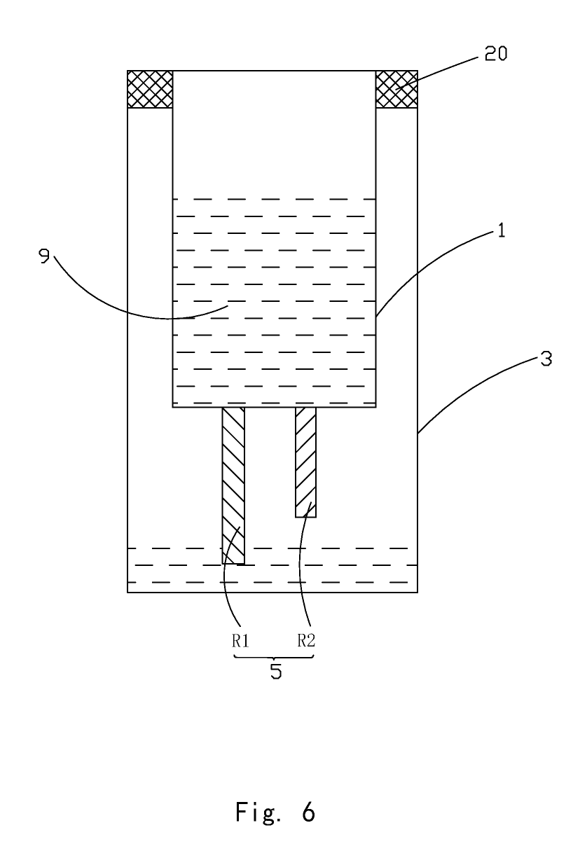

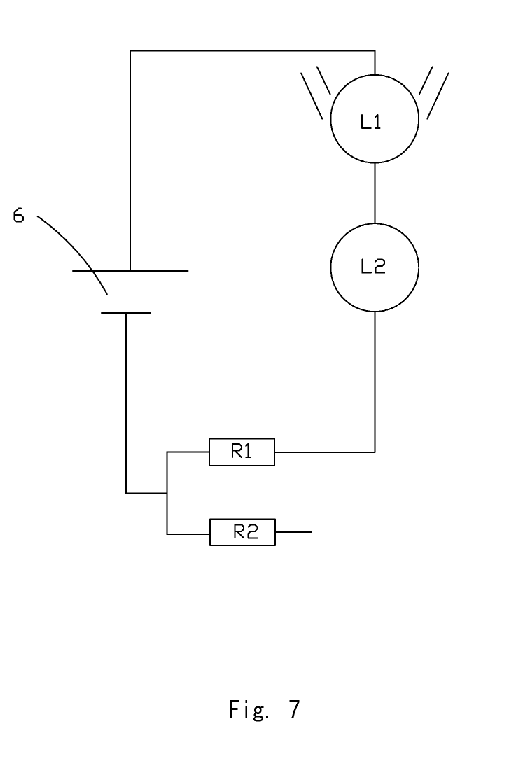

With reference to FIG. 6 and FIG. 7, when the inner heating container 1 generates micro cracks, a small amount of the high-temperature metal material 9 is leaked to the outer heating container 3, the first high resistance terminal R1 having a longer length contacts with the leaked high temperature metal material 9. The first high resistance terminal R1 electrically connects the inner heating container 1, the outer heating container 3, the power source 6, and the indication device 7. Therefore, the whole circuit is electrically conductive. At this time, the total resistance of the circuit is R1. The current in the circuit is smaller such that the current can only trigger the first indication light L1 having the lower initial current I1, which shows that the high-temperature metal material 9 leaks slightly. The second indication light L2 having the higher initial current I2 only flows through the current, but the second indication light L2 does not emit lights.

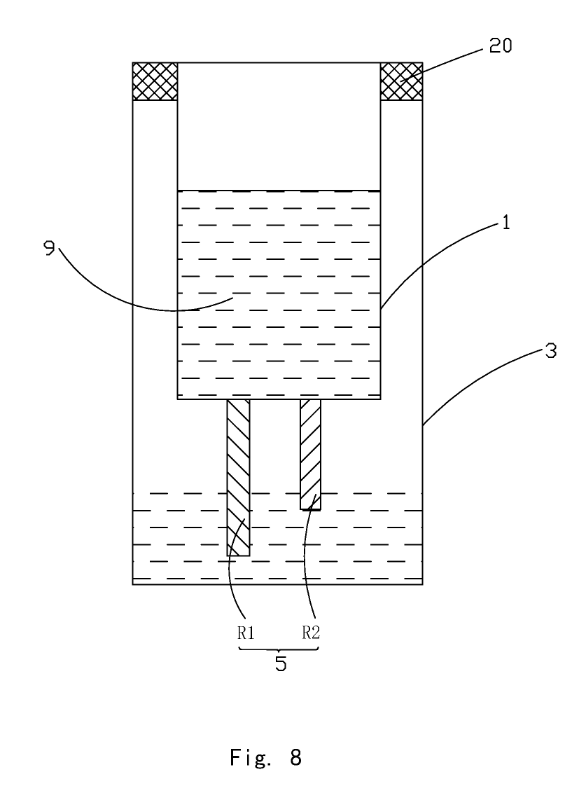

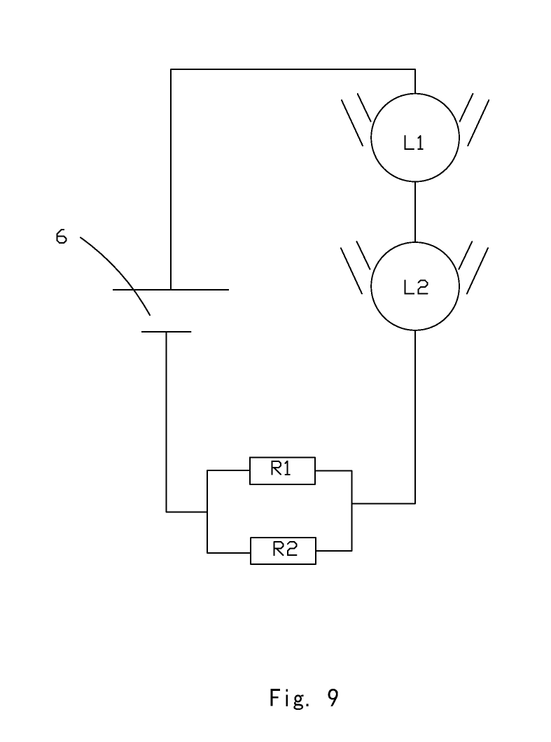

With reference to FIG. 8 and FIG. 9, when the inner heating container 1 seriously generates micro cracks so that the high-temperature metal material 9 largely leaks to the outer heating container 3, the first high resistance terminal R1 having a longer length and the second high resistance terminal R2 having a shorter length simultaneously contact the leaked high-temperature metal material 9. The first high resistance terminal R1 and the second high resistance terminal R2 form a parallel connection relationship so as to electrically connect the inner heating container 1, the outer heating container 3, the power source 6, and the indication device 7. The whole circuit is electrically conductive. At this time, the total resistance of the circuit is (R1×R2)/(R1+R2), which is lower than R1. Therefore, the current in the circuit is increased to trigger the first indication light L1 having the lower initial current I1 and the second indication light L2 having the higher initial current I2 to emit lights simultaneously, which shows that the high-temperature metal material 9 leaks largely. The technical person can execute corresponding steps to prevent the high-temperature metal material 9 from leaking further.

Similarly, when the heating device comprises more terminals 5 and indication lights 75, a different number of the terminals 5 contact with the leaked high-temperature metal material 9 such that the resistance of the circuit is different. The current flowing through the circuit is also different in order to trigger a different number of indication lights 75 to emit lights. The above can show an approximate height of the leaked high-temperature metal material 9 in order to precisely detect and determine the leakage amount, and instruct the technical person to execute corresponding steps in order to prevent the high-temperature metal material 9 from leaking further. Therefore, the normal and steady production of the OLED is maintained.

In summary, the heating device for detecting and preventing a high-temperature metal material from leaking of the present invention can observe the emitting status of the indication lights of the indication device through disposing a two-layer structure of the inner heating container and the outer heating container, and disposing the terminals with different lengths, the power source, and the indication device. The heating device can timely and conveniently detect the leakage of the high-temperature metal material in order to instruct the technical person to execute corresponding steps to prevent the high-temperature metal material from leaking further. The heating device can overcome the problem of losing metal material because of the damage of the heating container in order to reduce the cost, protect the heating device, and maintain the normal and steady production of the OLED.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

What is claimed is:

1. A heating device for detecting and preventing a high-temperature metal material from leaking, comprising:
an inner heating container for containing the high-temperature metal material;
an outer heating container disposed outside the inner heating container;
multiple terminals disposed at a bottom of the inner heating container and disposed without contacting a bottom of the outer heating container;
an insulation connector connecting the inner heating container and the outer heating container;
a power source; and
an indication device;
wherein, when the high-temperature metal material is not leaked, the inner heating container, the outer heating container, the multiple terminals, the power source, and the indication device form an open circuit; when the high-temperature metal material is leaked to the outer heating container, one or more of the multiple terminals contact the leaked high-temperature metal material so as to electrically connect the inner heating container, the outer heating container, the power source, and the indication device, and to trigger the indication device to work in order to determine that the high-temperature metal material is leaked and executing steps timely so as to prevent the high-temperature metal material from leaking further.

2. The heating device for detecting and preventing the high-temperature metal material from leaking according to claim 1, wherein, the each of the multiple terminals has a high resistance.

3. The heating device for detecting and preventing the high-temperature metal material from leaking according to claim 2, wherein, the multiple terminals are different in length; each of the multiple terminals does not contact with the bottom of the outer heating container; the indication device comprises multiple indication lights electrically connected with the power source; when the high-temperature metal material is leaked to the outer heating container, one or more of the multiple terminals contact with the leaked high-temperature metal material so as to electrically connect the inner heating container, the outer heating container, the power source, and the indication device, and to trigger one or more of the indication lights to emit lights in order to determine that the high-temperature metal material is leaked, and to determine that the degree of the leakage according to the number of the indication lights which emitting lights.

4. The heating device for detecting and preventing the high-temperature metal material from leaking according to claim 1, wherein, the inner heating container and the outer heating container are both made of electrically conductive materials, and the materials for the inner heating container and the outer heating container are the same.

5. The heating device for detecting and preventing the high-temperature metal material from leaking according to claim 1, wherein, an inner diameter of the outer heating container is larger than an outer diameter of the inner heating container; a height of the outer heating container is greater than a height of the inner heating container.

6. The heating device for detecting and preventing the high-temperature metal material from leaking according to claim 1, wherein, a top of the inner heating container is provide with a through hole, and the metal material is used for an organic light-emitting diode (OLED) evaporation process.

7. The heating device for detecting and preventing the high-temperature metal material from leaking according to claim 1, wherein, the insulation connector connects the top of the inner heating container and a top of the outer heating container.

8. The heating device for detecting and preventing the high-temperature metal material from leaking according to claim 1, wherein, the multiple terminals are fixed to the bottom of the inner heating container through welding.

9. The heating device for detecting and preventing the high-temperature metal material from leaking according to claim 3, wherein, the power source is a micro button cell battery; each of the multiple indication lights has an initial current and a color, and the initial currents and the colors are different; when a current is lower than the initial current of one of the multiple indication lights, the one of the multiple indication lights does not emit lights, and the current only flows through the one of the multiple indication lights; when a current reaches the initial current of the one of the multiple indication lights, the one of the multiple indication lights emits lights.

10. The heating device for detecting and preventing the high-temperature metal material from leaking according to claim 9, wherein, the number of the multiple terminals is at least two; the number of the multiple indication lights is at least two; the number of the multiple terminals is equal to the number of the multiple indication lights; the multiple terminals form a parallel connection relationship; the multiple indication lights form a series connection relationship.

11. A heating device for detecting and preventing a high-temperature metal material from leaking, comprising:
an inner heating container for containing the high-temperature metal material;
an outer heating container disposed outside the inner heating container;
multiple terminals disposed at a bottom of the inner heating container and disposed without contacting a bottom of the outer heating container;
an insulation connector connecting the inner heating container and the outer heating container;
a power source; and
an indication device;
wherein, when the high-temperature metal material is not leaked, the inner heating container, the outer heating container, the multiple terminals, the power source, and the indication device form an open circuit; when the high-temperature metal material is leaked to the outer heating container, one or more of the multiple terminals contact the leaked high-temperature metal material so as to electrically connect the inner heating container, the outer heating container, the power source, and the indication device, and to trigger the indication device to work in order to determine that the high-temperature metal material is leaked and executing steps timely so as to prevent the high-temperature metal material from leaking further;
wherein, the each of the multiple terminals has a high resistance;
wherein, the multiple terminals are different in length; each of the multiple terminals does not contact with the bottom of the outer heating container; the indication device comprises multiple indication lights electrically connected with the power source; when the high-temperature metal material is leaked to the outer heating container, one or more of the multiple terminals contact with the leaked high-temperature metal material so as to electrically connect the inner heating container, the outer heating container, the power source, and the indication device, and to trigger one or more of the indication lights to emit lights in order to determine that the high-temperature metal material is leaked, and to determine that the degree of the leakage according to the number of the indication lights which emitting lights;
wherein, the inner heating container and the outer heating container are both made of electrically conductive materials and the materials for the inner heating container and the outer heating container are the same;
wherein, an inner diameter of the outer heating container is larger than an outer diameter of the inner heating container; a height of the outer heating container is greater than a height of the inner heating container;
wherein, a top of the inner heating container provides with a through hole, and the metal material is used for an organic light-emitting diode (OLED) evaporation process;
wherein, the insulation connector connects the top of the inner heating container and a top of the outer heating container;
wherein, the multiple terminals are fixed to the bottom of the inner heating container through welding;
wherein, the power source is a micro button cell battery; each of the multiple indication lights has an initial current and a color, and the initial currents and the colors are different; when a current is lower than the initial current of one of the multiple indication lights, the one of the multiple indication lights does not emit lights, and the current only flows through the one of the multiple indication lights; when a current reaches the initial current of the one of the multiple indication lights, the one of the multiple indication lights emits lights; and
wherein, the number of the multiple terminals is at least two; the number of the multiple indication lights is at least two; the number of the multiple terminals is equal to the number of the multiple indication lights; the multiple terminals form a parallel connection relationship; the multiple indication lights form a series connection relationship.
